(19) United States
(12) Patent Application Publication
(10) Pub. No.: US 2022/0105945 A1
(43) Pub. Date: Apr. 7, 2022

(54) COMPUTING DEVICE FOR AN AUTOMATED VEHICLE

(71) Applicant: ZF Friedrichshafen AG, Friedrichshafen (DE)

(72) Inventor: Stefan BELLER, Friedrichshafen (DE)

(73) Assignee: ZF Friedrichshafen AG, Friedrichshafen (DE)

(21) Appl. No.: 17/484,889

(22) Filed: Sep. 24, 2021

(30) Foreign Application Priority Data
Oct. 1, 2020 (DE) 102020212433.7

(51) Int. Cl. B60W 40/02; B60W 60/00; B60W 50/14

(52) U.S. Cl. CPC B60W 40/02; B60W 2552/00; B60W 50/14; B60W 60/0016

(57) ABSTRACT

A computing device for an automated vehicle for identifying high tension power lines is proposed, comprising at least one first interface for receiving object data regarding at least one overhead power line pole in an environment of the automated vehicle, at least one computing module intended for evaluating the object data to classify the overhead power line pole in a pole class in order to determine a course of the power lines on the basis of the classification and to determine at least one control or regulating signal for a vehicle control unit in the automated vehicle on the basis of the determined course of the power lines, and at least one second interface for providing the control or regulating signal to the vehicle control unit.

The invention relates to a computing device for an automated vehicle for identifying high tension power lines. The invention also relates to a system for an automated vehicle and a corresponding automated vehicle. The invention furthermore relates to a method implemented by a computer for identifying high tension power lines, and a corresponding computer program.

Systems for identifying high tension power lines are known from the prior art. By way of example, DE 10 2007 014 878 A1 describes the identification of power lines by means of sensors in a helicopter. EP 3 549 441 A1 discloses the identification of power lines by agricultural machines based on ozone concentrations.

A computing device for an automated vehicle is proposed for identifying high tension power lines. The computing device comprises at least one first interface for receiving object data relating to at least one overhead power line pole located in the environment of an automated vehicle. The computing device comprises at least one computing module that is configured to evaluate the object data in order to classify the overhead power line pole in a class of poles to determine the course of the power line on the basis of the classification, and to determine at least one control or regulating signal for a vehicle control unit in the automated vehicle on the basis of the determined course of the power line. The computing device comprises at least one second interface for providing the control or regulation signal to the vehicle control unit.

An “automated vehicle” is understood to be a vehicle in particular with one of the automation classifications 1 to 5 according to the SAE J3016 standard. In particular, the automated vehicle contains the technological equipment necessary for these automation classifications. The technological equipment comprises environment detection sensors, e.g. radar sensors, lidar sensors, cameras, and/or acoustic sensors, control units, etc. The automated vehicle is preferably a land vehicle. This automated vehicle can be a passenger automobile, preferably for transporting people, a truck, a construction site vehicle, an agricultural vehicle, or some other vehicle that makes sense in this context to the person skilled in the art. The automated vehicle can also be an aircraft, e.g. a drone, airplane, helicopter, vertical take-off and landing aircraft, etc. The term “intended as” is to be understood in particular as meaning specially programmed, specially equipped, and/or specially configured for. If an object is “intended for” something in particular, this means that the object can execute the function in at least one operating state.

In particular, a control unit, e.g. an electronic control unit, can comprise or at least partially form the automated vehicle. A control unit prepares data from sensors as input signals, processes these signals by means of the computing device, in particular by means of the computing module, e.g. a programmable logic module, an FPGA or ASIC, or a computer platform, and provides logic and/or power levels as control or regulating signals. Actuators for longitudinal and/or lateral control of the vehicle are controlled or regulated with the control or regulating signals via the second interface, in order to keep the vehicle in its lane and/or predict a trajectory thereof. The control unit is preferably integrated in an electrical system in the vehicle, e.g. in a CAN bus. The control unit is an electronic control unit, by way of example, for automated vehicle functions, referred to in English as a domain ECU. In particular, the control unit can be an ADAS (advanced driver assistance system)/AD (autonomous driving) domain ECU for assisted to fully automated, i.e. autonomous, driving.

The computing device, in particular the computing module, is implemented in particular as a system-on-a-chip with a modular hardware concept, i.e. all, or at least a majority, of the functions are integrated on a chip, and can be expanded in a modular manner. The chip can be integrated in particular in the control unit. The computing device, in particular the computing module, comprises a multi-core processor and memory modules. The multi-core processor is configured for signa/data exchange with storage mediums. By way of example, the multi-core processor comprises a bus system. The memory modules form a working memory. The memory modules are RAM, DRAM, SDRAM, or SRAM. In a multi-core processor there are numerous cores on a single chip, i.e. a semiconductor component. Multi-core processors obtain a high computing power and are more economical to implement in a chip than multi-processor systems, in which each individual core is located in a processor socket, and the individual processor sockets are located on a main circuit board. The computing device, in particular the computing module, comprises at least one central processing unit (CPU) according to one aspect of the invention.

The computing device, in particular the computing module, preferably also comprises at least one graphics processor, referred to in English as a graphics processing unit (GPU). Graphics processing units have a special micro-architecture for processing sequences in parallel. According to one aspect of the invention, the graphics processing unit comprises at least one processor, which is specifically configured for executing tensor and/or matrix multiplications. Tensor and/or matrix multiplications are the central computing operations in deep learning. The computing device, in particular the computing module, also comprises hardware accelerators for artificial intelligence according to one aspect of the invention, e.g. so-called deep learning accelerators. According to another aspect of the invention, a classifier is provided in the programming technology CUDA. Consequently, software code sections of the classifier are processed directly by the GPU. The computing device or control unit are configured such that they can be expanded with numerous, e.g. at least four, such chips in a modular manner.

An interface, in particular the first interface and second interface in the computing unit is/are preferably intended for data exchange. This data exchange is designed in particular as a signal transfer of an electrical signal in particular. The data exchange preferably takes place at the interfaces in either a wireless or hard-wired manner. The first interface is preferably intended for sending data, in particular object data, to the computing module, from a detection unit connected for data transfer connected to the computing module. The second interface is preferably intended for outputting certain signals, in particular control or regulating signals, determined by the computing module. In particular, the second interface is intended for outputting the control or regulating signals to the vehicle control unit. In particular, the computing module is connected to the vehicle control unit for signal transfer via the second interface.

The vehicle control unit is preferably intended for controlling movement of the automated vehicle, in particular in a driving mode. In particular, the vehicle control unit comprises actuators for longitudinal and lateral guidance of the automated vehicle. In particular, the actuators can be controlled by means of the control or regulating signals determined by the computing module. An actuator for lateral guidance can form an electric motor for an electromechanical power steering system.

The overhead power line pole is preferably designed as a high tension power line pole. The overhead power line pole can also be designed as a medium voltage power line pole, a low voltage power line pole, or some other overhead power line pole regarded as reasonable by the person skilled in the art, e.g. a telephone pole. The vehicle's environment is formed in particular by a region lying within a specific radius surrounding the vehicle. The environment of the vehicle, in particular in the form of a land vehicle, preferably comprises at least one roadside, in particular within the range of the environment detection sensors. The environment comprises regions in particular surrounding a movement path for the vehicle, in particular a roadway. The environment of an aircraft can be formed in particular by the airspace surrounding the aircraft.

The object data for the overhead power line pole can relate to the presence of an overhead power line pole, a position of the overhead power line pole, in particular in relation to the vehicle, the dimensions of the overhead power line pole, in particular the height of the overhead power line pole, a distance to the overline power line pole to another neighboring overhead power line pole, etc. The detection unit is preferably intended for detecting object data for numerous overhead power line poles in the vehicle's environment, and provide these data to the computing module via the first interface. The detection unit is preferably intended for detecting objects other than overhead power line poles in the vehicle's environment, and providing object data relating to these objects to the computing module via the first interface. The other objects can be trees, wind turbines, cranes, buildings, or other objects regarded by the person skilled in the art as relevant. The computing module is preferably intended for evaluating the object data for the overhead power line poles and other objects, in order to identify the overhead power line poles as overhead power line poles, and the distinguish them from the other objects. The computing module is preferably intended for combining object data for the overhead power line poles detected by means of various sensors with one another, in particular by merging these object data. The computing module is preferably intended to evaluate the combined object data in order to classify the overhead power line poles in a class of poles. According to one aspect of the invention, the computing module executes program instructions in order to evaluate the object data to classify the overhead power line poles in a class of poles. According to another aspect of the invention, the program instructions comprise a machine learning algorithm that is trained to determine the class of pole for the overhead power line pole from the object data it receives. The machine learning algorithm forms an artificial neural network, by way of example.

A class of poles preferably comprises subclasses, structural types, and specific types. The computing module is intended in particular for classifying the overhead power line pole in at least one subclass, preferably in at least one subclass and one structural type, and particularly preferably in at least one subclass, one structural type, and one specific type. The subclass can form, in particular a supporting pole, tension pole, a long distance tension pole, a transposition pole, a branching pole, a terminal pole, an end pole, a transformer pole, a pole separator, etc. The structural type can be a portal pole, a delta pole, a leveling pole, a Danube pole, a tri-level pole, a pylon pole, a Christmas tree pole, a compact pole, etc. The specific type can be rail line power pole, a catenary line pole, a hybrid pole, a telephone pole, a telegram pole, etc.

The computing module is preferably intended for determining the course of the power lines on at least one overhead power line pole, in particular the power lines supported by the overhead power line pole, in particular high tension lines, on the basis of the classification of the overhead power line pole. In particular, a direct detection of power lines and their courses may be difficult due to the small cross sections of the power lines. In particular, the course of the power lines depends on the class of the overhead power line pole. By way of example, it is conceivable that a support pole may have numerous high tension lines that are higher above the ground than those supported by a tension pole. The computing module is preferably trained to determine the courses of power lines by means of a machine learning process, based on classes of poles. Alternatively or additionally, it is conceivable that a memory in the computing module contains a data base with power line course assigned to different classes of poles.

The computing module is preferably intended for determining a control or regulating signal for the vehicle control unit based on the course of the power line. In particular, the computing module is intended to determine a minimum safety distance to the power line for the automated vehicle based on the determined course of the power line. The computing module is preferably intended to determine a control or regulating signal for the vehicle control unit based on the determined minimum safety distance. Depending on the different courses of the power lines, in particular the different safety distances, the control or regulating signal can comprise different commands, e.g. corresponding to an output of a warning signal, executing an emergency braking, executing a change in course, recalculating a navigation route, updating map data, etc. As an alternative or in addition to determining the control or regulating signal, it is conceivable that the computing module is intended for executing other actions, e.g. comparing the determined course of the power line with a planned route and/or the height of the vehicle, to verify the course of the power line through communication with other objects (V2X communication) in particular other road users (V2V communication), etc.

A reliable determination of the course of the power lines can advantageously be enabled through the design of the computing device according to the invention. Advantageously, there is no need for an unreliable direct identification of power lines. Advantageously, the danger of power lines can be reduced in an anticipatory manner. Advantageously, a high level of safety for vehicle occupants can be obtained. Advantageously, traffic and infrastructure safety can be increased.

It is also proposed that the computing module is intended to evaluate the object data in order to determine a characteristic value for the insulators on an overhead power line pole in order to classify the overhead power line pole in a pole class. In particular, the overhead power line pole comprises at least one insulator, to which the at least one power line is attached. In particular, different overhead power line poles can have different insulators and different characteristic values for insulators. The characteristic value for the insulator can form a type of insulator, a group of insulators, a number of insulators, a distribution and/or placement of insulators on a body on the overhead power line pole, etc. The computing module is preferably intended to determine numerous characteristic values for insulators. In particular, the computing module is intended to classify the overhead power line pole in a class of poles based on the characteristic values of insulators, or at least take the characteristic values for the insulators into account in a classification of the overhead power line pole. This advantageously enables a precise classification of overhead power line poles.

It is also proposed that the computing module is intended to evaluate the object data for determining an orientation of the overhead power line pole. “Orientation” of an overhead power line pole is understood in particular to mean an angular position of the overhead power line pole in relation to a vertical axis of the overhead power line pole, in particular in relation to the vehicle, and/or an angle of the vertical axis of the overhead power line pole in relation to the perpendicular, in particular in relation to the vehicle. A “vertical axis” of an overhead power line pole should be understood in particular to refer to an axis of the overhead power line pole extending perpendicular to a substrate in which the overhead power line pole is anchored. In particular, a course of the power line is dependent on the orientation of the overhead power line pole. Further information regarding overhead power line poles can advantageously be determined.

It is also proposed that the computing module is intended to determine the orientation of the overhead power line pole based on lateral beams and/or insulators on the overhead power line pole. Lateral beams are arms in particular on the overhead power line poles, that are at a right angle to the vertical axis of the overhead power line pole. In particular, at least a portion, preferably a majority, of the insulators on the overhead power line poles are located on the lateral beams. The lateral beams and/or insulators of overhead power line poles with different orientations have different orientations. By way of example, lateral beams on two overhead power line poles with different angular positions point in different cardinal directions about the vertical axes. The orientations of overhead power line poles can advantageously be determined on the basis of precisely obtained object data.

It is also proposed that the computing module is intended to take an orientation of the overhead power line poles into account in determining a course of the power lines. In particular, a power line runs at least in sections at a right angle to the vertical axis of the overhead power line pole, and in a direction transverse to a main extension of the lateral beams. The computing module is preferably intended to take the orientations of neighboring overhead power line poles in relation to one another into account in determining the course of the power lines. Advantageously, the course of the power lines can be determined in a particularly precise manner.

It is also proposed that the computing module is intended to determine a minimum safety distance to the power line based on the determined course of the power line. A “minimum safety distance” to the power line should be understood to be a distance from the automated vehicle to the power line at which there is no danger to the vehicle, in particular for the occupants of the vehicle, from the power line. The computing module is preferably intended to take any sagging of the power line between neighboring overhead power line poles into account in determining the minimum safety distance. The computing module is preferably intended to take a predefined, in particular legal, minimum distance between the vehicle and a power line into account in determining the minimum safety distance. The computing module is preferably intended to include a safety buffer, in particular to compensate for a possible miscalculations and/or incorrect classifications, in the determination of the minimum safety distance. Advantageously, this results in a particularly high level of traffic safety.

It is also proposed that the computing module is intended to determine an approximate voltage of the power line based on the pole class for the overhead power line pole. In particular, different voltages may be conducted by power lines on different overhead power line poles. This advantageously results in being able to determine a further safety-relevant characteristic value.

It is also proposed that the computing module is intended to take the determined approximate voltage on the power line into account in determining the minimum safety distance. In particular, the computing module is intended to determine different minimum safety distances to the power line on the basis of different voltages on the power line. The computing module is preferably intended to determine a greater safety distance to the power line when the determined approximate voltage on the power line is greater. Advantageously, a particularly high level of traffic and infrastructure safety can be obtained in this manner.

It is also proposed that the computing module is intended to determine at least one control or regulating signal for the vehicle control unit corresponding to a warning for the vehicle occupants, in particular a driver, in the automated vehicle, based on the determined course of the power line. The computing module is preferably intended to send the control or regulating signal to the vehicle control unit via the second interface. In particular, the control or regulating signal comprises at least one command for the vehicle control unit to output a warning signal for the vehicle occupants. The warning signal can be an acoustic warning signal in particular, such as a signal tone. The warning signal can be an optical warning signal in particular, such as a blinking of a warning message on a screen or heads-up display, showing the determined course of the power line in a navigation map, etc. The warning signal can be a tactile warning signal in particular, such as a vibrating of the steering wheel, a tightening of the safety belt, etc. Advantageously, a vehicle occupant can be made aware of power lines in advance in this manner. This allows the occupants to take timely manual countermeasures.

It is also proposed that the computing module is intended to determine at least one control or regulating signal for the vehicle control unit corresponding to an automated driving maneuver for the automated vehicle on the basis of the determined course of the power line. The computing module is preferably intended to send the control or regulating signal to the vehicle control unit via the second interface. In particular, the control or regulating signal comprises at least one command for the vehicle control unit for executing the driving maneuver. In particular, the computing module can be intended to determine the control or regulating signal corresponding to an automated driving maneuver as an alternative or in addition to the control or regulating signal corresponding to a warning for the vehicle occupants. The driving maneuver can be a braking, accelerating, evading, route changing, or another maneuver regarded as reasonable by a person skilled in the art. In particular, the driving maneuver should prevent an accident with the power line, or at least reduce the consequences of an accident. Advantageously, an anticipatory automated safety function can be provided in this manner. This advantageously increases the safety for vehicle occupants.

A system for an automated vehicle for identifying high tension power lines is also proposed. The system comprises at least one computing device according to the invention. The system comprises at least one detection unit, in particular the aforementioned detection unit. The detection unit is intended to acquire object data for an overhead power line pole in the environment of the automated vehicle, and send this object data to the computing device via the first interface. The detection unit preferably comprises at least one sensor, in particular an environment detection sensor, for acquiring object data. The sensor can be a radar sensor, lidar sensor, camera, acoustic sensor, ultrasonic sensor, or some other sensor regarded by a person skilled in the art as useful for this. The detection unit preferably comprises numerous sensors. In particular, the detection unit can comprise numerous different sensors for acquiring different object data. Advantageously, object data can be reliably sent to the computing device in this manner.

An automated vehicle is also proposed. The automated vehicle comprises at least one detection unit, in particular the aforementioned detection unit, which is intended to acquire object data for at least one overhead power line pole in the environment of the automated vehicle. The automated vehicle comprises at least one vehicle control unit, in particular the aforementioned vehicle control unit. The automated vehicle comprises at least one computing device, in particular the aforementioned computing device, for identifying high tension power lines. The computing device has at least one first interface, in particular the aforementioned first interface, for receiving object data acquired from the detection device for at least one overhead power line pole in the environment of the automated vehicle. The computing device contains at least one computing module, in particular the aforementioned computing module, that is intended for evaluating the object data in order to classify the overhead power line pole in a pole class, in order to determine a course of the power line based on the classification, and to determine at least one control or regulating signal for the vehicle control unit based on the determined course of the power line. The computing device has at least one second interface, in particular the aforementioned second interface, for sending the control or regulating signal to the vehicle control unit. This results in an automated vehicle with an advantageously high level of safety for the vehicle occupants.

A computer-implemented method for identifying high tension power lines is also proposed. Object data for at least one overhead power line pole in the environment of an automated vehicle that have been received are evaluated in order to classify the overhead power line pole in a pole class, in order to determine a course of the power line based on the classification. Based on the determined course of the power line, at least one control or regulating signal is determined for a vehicle control unit, in particular the aforementioned vehicle control unit. This advantageously results in a method for safely identifying a hazard for a vehicle from power lines for the occupants of a vehicle and for the safety of the infrastructure.

A computer program is also proposed for identifying high tension power lines. The computer program comprises execution commands, with which the computing device according to the invention is able to execute the method according to the invention. As a result, a computer program is provided that is able to efficiently identify power lines.

The invention shall be explained in greater detail based on the exemplary embodiments shown in the drawings. Therein:

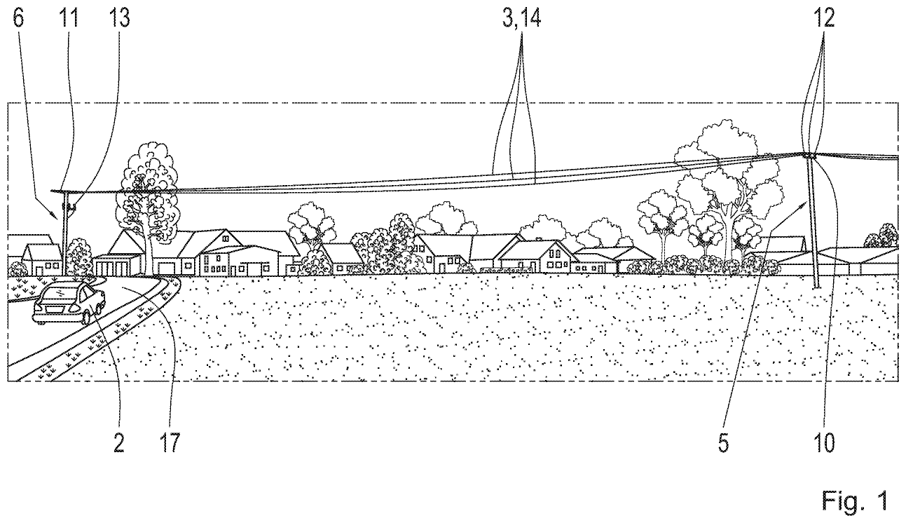

FIG. 1 shows an automated vehicle according to the invention, in an environment, in a schematic illustration;

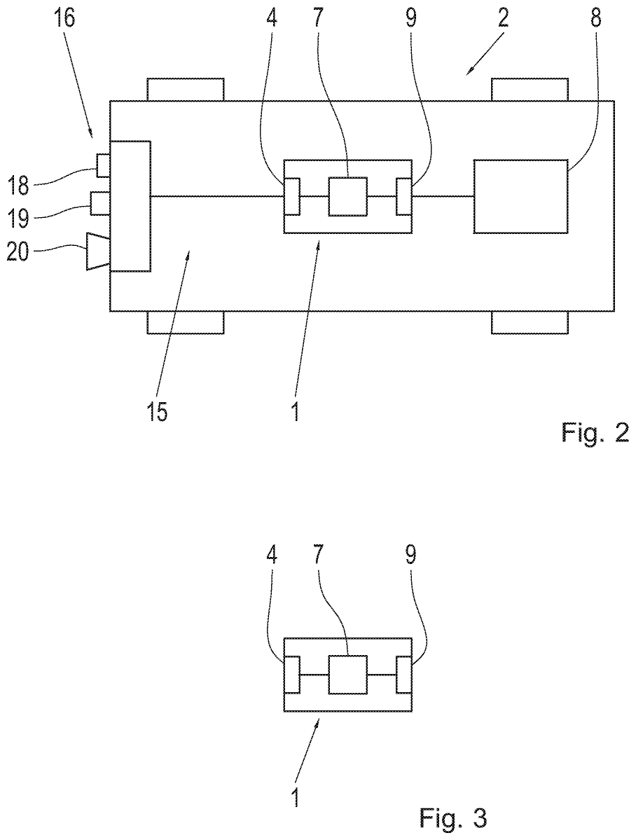

FIG. 2 shows the automated vehicle according to the invention from FIG. 1, in a schematic illustration;

FIG. 3 shows a computing device according to the invention, in a schematic illustration;

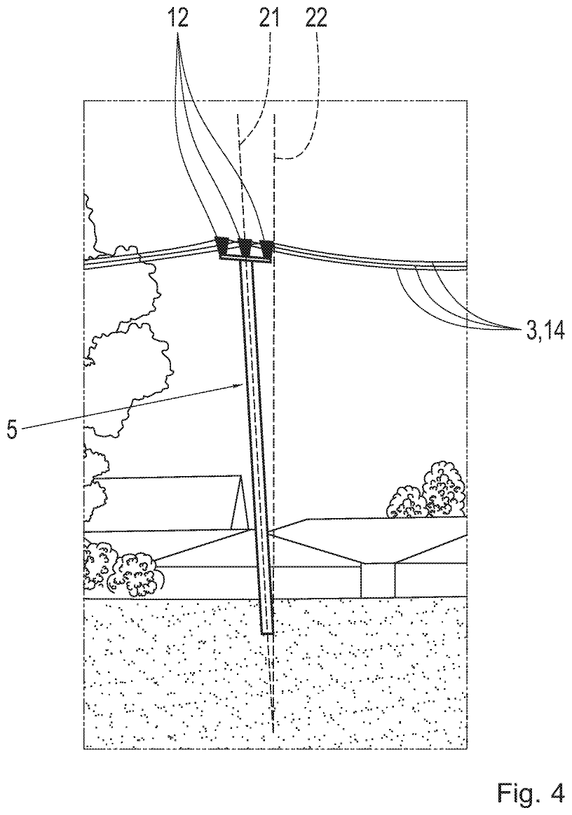

FIG. 4 shows an overhead power line pole in a schematic illustration; and

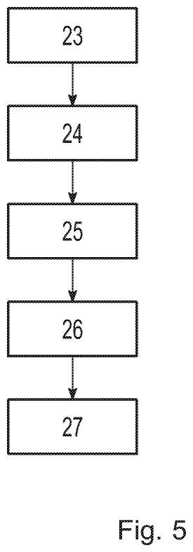

FIG. 5 shows a flow chart for a computer-implemented method according to the invention, in a schematic illustration.

FIG. 1 shows an automated vehicle 2 in a schematic illustration. The vehicle 2 is shown in an environment of the vehicle 2. The vehicle 2 is designed by way of example as a land vehicle, in particular a passenger automobile. Two overhead power line poles 5, 6 are located along the roadway 17 for the vehicle 2 in the present exemplary embodiment, by way of example. The overhead power line poles 5, 6 are on different sides of the roadway 17. A first overhead power line pole 5 is a supporting pole, by way of example. A second overhead power line pole 6 is an end pole, by way of example. Three power lines 14 in the form of high tension power lines 3 run between the overhead power line poles 5, 6. The power lines 14 extend over the roadway 17. Because of the high tension on the power lines 14, they present a hazard to the vehicle 2, in particular the vehicle occupants. In particular, the vehicle occupants could suffer an electric shock, etc., as a result of an accident of the vehicle 2 with the power lines 14. The vehicle 2 and/or the power lines 14 could also be damaged as a result of an accident of the vehicle 2 with the power lines 14. Damage to the power lines 14 could result in further damages, e.g. overloads to electrical devices that are supplied with electricity by the power lines 14. It is therefore important to identify the power lines 14 with regard to traffic and infrastructure safety.

The automated vehicle 2 comprises at least one detection unit 16 that is intended for acquiring object data regarding the overhead power line poles 5, 6 (cf. FIG. 2). The automated vehicle 2 comprises at least one computing device 1 for identifying high tension power lines 3 (cf. FIG. 2). The computing device 1 and the detection device 16 form a system for the automated vehicle 2.

FIG. 2 shows the automated vehicle 2 from FIG. 1 in a schematic illustration, in particular isolated from the environment shown in FIG. 1. The automated vehicle 2 comprises at least one vehicle control unit 8. The computing device 1 has at least one first interface 4 for receiving object data regarding overhead power line poles 5, 6 in the environment of the automated vehicle 2 from the detection unit 16. The computing device 1 has at least one computing module 7 that is intended for evaluating the object data in order to classify the overhead power line poles 5, 6 in a pole class, in order to determine a course of the power lines based on the classification, and to determine at least one control or regulating signal for the vehicle control unit 8 on the basis of the determined course of the power lines. The computing device 1 has at least one second interface for providing the control or regulating signal to the vehicle control unit 8.

The detection unit 16 comprises numerous different sensors 18, 19, 20, three in the present exemplary embodiment, which are environment detection sensors in particular. The sensors 18, 19, 20 are intended for acquiring different object data for the overhead power line poles 5, 6. By way of example, a first sensor 18 is a lidar sensor, a second sensor 19 is a radar sensor, and a third sensor 20 is a camera. The detection unit 16 can alternatively or additionally also be an acoustic sensor, an ultrasonic sensor, or another sensor that appears to be relevant to the person skilled in the art.

The computing module 7 is intended to combine, in particular merge, different object data for the overhead power line poles 5, 6 acquired by means of the different sensors 18, 19, 20. The computing module 7 is intended to evaluate the combined object data to classify the overhead power line poles 5, 6 in a pole class. The computing module 7 executes program instructions in order to evaluate the object data to classify the overhead power line poles 5, 6 in a pole class. The program instructions comprise a machine learning algorithm, which is trained to determine the pole class for the overhead power line poles 5, 6 from the object data that are received. The machine learning algorithm and/or another machine learning algorithm in the program instructions are/is trained to determine a course of the power lines on the basis of the pole class. The machine learning algorithm is designed, for example, as an artificial neural network.

FIG. 3 shows the computing device 1 in a schematic illustration. The computing device 1 comprises the computing module 7, the first interface 4, and the second interface 9.

FIG. 4 shows the first overhead power line pole 5 in a schematic illustration. The computing module 7 is intended to evaluate the object data in order to determine an orientation of the overhead power line poles 5, 6. The computing module 7 is intended to determine the orientation of the overhead power line poles 5, 6 on the basis of lateral beams 10, 11 and/or insulators 12, 13 on the overhead power line poles 5, 6. The computing module 7 is intended to take an orientation of the overhead power line poles 5, 6 into account in determining the course of the power lines.

The orientation of the first overhead power line pole 5 can be readily seen in FIG. 4. By way of example, a vertical axis 21 of the first overhead power line pole 5 is tilted in relation to the perpendicular 22. An angular position of the first overhead power line pole 5 about the vertical axis 21 of the first overhead power line pole 5 can be identified on the basis of the orientation of the lateral beam 10 on the first overhead power line pole 5.

FIG. 5 shows a flow chart for a computer-implemented method for identifying high tension power lines 3, in a schematic illustration. In a first step 23, object data for overhead power line poles 5, 6 in the environment of the automated vehicle 2 are received. The received object data are evaluated in order to classify the overhead power line poles 5, 6 in a pole class in a second step 24. A course of the power lines is determined in a third step 25 on the basis of the classification. At least one control or regulating signal for the vehicle control unit 8 is determined in a fourth step 26 on the basis of the determined power line course. The control or regulating signal is sent to the vehicle control unit 8 in a fifth step 27.

A computer program for identifying high tension power lines 3 comprises executing commands with which the method is executed when the program is executed by the computing device 1.

### REFERENCE SYMBOLS

1 computing device

2 automated vehicle

3 high tension power line

4 first interface

5 first overhead power line pole

6 second overhead power line pole

7 computing module

8 vehicle control unit

9 second interface

10 lateral beam

11 lateral beam

12 insulator

13 insulator

14 power line

15 system

16 detection unit

17 roadway

18 first sensor

19 second sensor

20 third sensor

21 vertical axis

22 perpendicular

23 first method step

24 second method step

25 third method step

26 fourth method step

27 fifth method step

1. A computing device for an automated vehicle for identifying high tension power lines, the computing device comprising;
at least one first interface configured to receive object data regarding at least one overhead power line pole in an environment of the automated vehicle;
at least one computing module configured to evaluate the object data to classify the overhead power line pole in a pole class in order to determine a course of the power lines on the basis of the classification and to determine at least one control or regulating signal for a vehicle control unit in the automated vehicle on the basis of the determined course of the power lines; and
at least one second interface configured to provide the at least one control or regulating signal to the vehicle control unit.

2. The computing device according to claim 1, wherein the computing module is configured to evaluate the object data to determine a characteristic value for an insulator on the overhead power line pole in order to classify the overhead power line pole in the pole class.

3. The computing device according to claim 1, wherein the computing module is configured to evaluate the object data to determine an orientation of the overhead power line pole.

4. The computing device according to claim 3, wherein the computing module is configured to determine the orientation of the overhead power line pole on the basis of at least one of lateral beams or insulators on the overhead power line pole.

5. The computing device according to claim 1, wherein the computing module is configured to take an orientation of the overhead power line pole into account in the determination of the course of the power line.

6. The computing device according to claim 1, wherein the computing module is configured to determine a minimum safety distance to the power line on the basis of the determined course of the power line.

7. The computing device according to claim 1, wherein the computing module is configured to determine an approximate voltage on the power line on the basis of the pole class for the overhead power line pole.

8. The computing device according to claim 7, wherein the computing module is configured to take the determined approximate voltage on the power line into account in determining the minimum safety distance to the power line.

9. The computing device according to claim 1, wherein the computing module is configured to determine the at least one control or regulating signal for the vehicle control unit corresponding to a warning for vehicle occupants in the automated vehicle on the basis of the determined course of the power line.

10. The computing device according to claim 1, wherein the computing module is configured to determine the at least one control or regulating signal for the vehicle control unit corresponding to an automated driving maneuver for the automated vehicle on the basis of the determined course of the power line.

11. A system for an automated vehicle for identifying high tension power lines, comprising:
the computing device according to claim 1; and
at least one detection unit configured to acquire object data for the at least one overhead power line pole in the environment of the automated vehicle and provide the object data to the computing device via the first interface.

12. An automated vehicle comprising the system according to claim 11.

13. A computer-implemented method for identifying high tension power lines, the method comprising:
evaluating, by a computing device, object data regarding at least one overhead power line pole located in an environment of an automated vehicle to classify the overhead power line pole in a pole class in order to determine a course of the power line on the basis of the classification;
determining, by the computing device, at least one control or regulating signal is determined for a vehicle control unit on the basis of the determined course of the power line; and
providing, by the computing device, the control or regulating signal to the vehicle control unit.

14. (canceled)

15. The method according to claim 13, further comprising:
evaluating, by the computing device, the object data to determine a characteristic value for an insulator on the overhead power line pole in order to classify the overhead power line pole in the pole class.

16. The method according to claim 13, further comprising:
evaluating, by the computing device, the object data to determine an orientation of the overhead power line pole.

17. The method according to claim 16, further comprising:
determining, by the computing device, the course of the power line in part by taking the orientation of the overhead power line pole into account.

18. The method according to claim 13, further comprising:
determining, by the computing device, a minimum safety distance to the power line on the basis of the determined course of the power line.

19. The method according to claim 13, further comprising:
determining an approximate voltage on the power line on the basis of the pole class for the overhead power line pole; and
determining, by the computing device, a minimum safety distance to the power line on the basis of the determined approximate voltage on the power line.

20. A non-transitory computer-readable medium comprising at least one computer program that, when executed by at least one computing device, causes the computing device to perform a method comprising:
evaluating object data regarding at least one overhead power line pole located in an environment of an automated vehicle to classify the overhead power line pole in a pole class in order to determine a course of the power line on the basis of the classification;
determining at least one control or regulating signal for a vehicle control unit on the basis of the determined course of the power line; and
providing, by the computing device, the control or regulating signal to the vehicle control unit.

21. The non-transitory computer-readable medium, wherein the computer program causes the computing device to perform the method further comprising:
determining, by the computing device, a minimum safety distance to the power line on the basis of the determined course of the power line.
